(19) United States
(12) Patent Application Publication
(10) Pub. No.: US 2007/0079918 A1
(43) Pub. Date: Apr. 12, 2007

(54) Tear propagation resistant film-backed adhesive tape

(75) Inventor: Ilse Rodewald, Hamburg (DE)

Correspondence Address: William C. Gerstenzang;Norris, McLaughlin & Marcus P.A., 875 Third Avenue - 18th Floor, New York, NY, 10022, US

(73) Assignee: tesa AG, Hamburg (DE)

(21) Appl. No.: 11/515,808

(22) Filed: Sep. 5, 2006

(30) Foreign Application Priority Data
Oct. 12, 2005 (DE) 10 2005 049 342.4

(51) Int. Cl. B32B 37/12; B32B 7/12

(52) U.S. Cl. 156/60; 428/343; 428/354

(57) ABSTRACT

Adhesive tape with a backing of a polymer material and with an adhesive, wherein the backing material is composed of a multiplicity of strips which are oriented in machine direction and aligned in machine direction, the multiplicity of strips being fixed to one another by means of an auxiliary backing film.

The invention relates to an adhesive tape having a film backing which is oriented in machine direction, which is protected against tear propagation by the production of a plurality of undamaged film side edges across the width of the adhesive tape, and to its use.

### BACKGROUND OF THE INVENTION

The problem of the tear propagation resistance of backing materials in adhesive tapes is well known. Films which are monoaxially oriented for the purpose of achieving a high longitudinal tensile strength typically have the drawback of a drastically reduced tear propagation resistance.

Solutions to this problem are based on a variety of approaches, one example being the fibre reinforcement of the backing material. Conventional market adhesive tapes include what are called “filament” adhesive tapes, with unidirectional lengthwise nonwoven scrims or bidirectional woven or nonwoven scrims, composed of twisted or tangled yarns. These yarns may be composed, for example, of synthetic continuous fibres or else of natural fibres. The fibres in this kind of adhesive tapes, however, are always held together to form locally fixed fibre or filament bundles. The fibres introduced in this way, as well as increasing the tear propagation resistance, may also take on the function of a variable fraction of the tensile strength, the intention being thereby to solve the problem of the tear propagation resistance of film backings. Fibre-reinforced backing films, however, have a good number of disadvantages. Glass filaments, for example, are not resistant to crease fracture. With filament reinforcement, additionally, the fibres are not equally long and do not have a strict order, which means that directed tensile forces cannot be effectively absorbed. Additionally, in the case of woven structures, the warp threads undergo an additional deflection in the z direction at their nodal points. In the event of tensile load, this additional length must first be pulled up before the tensile strength properties of the yarn come to bear. Moreover, this makes it very difficult to reduce the adhesive tape thickness. Another solution offered to this problem is, for example, an oriented film composed of at least two coextruded layers of different composition, with an irregular internal structure, as depicted in DE 199 55 610 A1. In that case the thickness of one of these layers varies in inverse proportion to the second layer across the width of the adhesive tape, while the overall thickness is constant. As a result of the different mechanical properties of the layers, a tear which begins in the transverse direction is turned round into the longitudinal direction. An obvious disadvantage of this process, however, is the complicated machinery needed to produce this type of film.

Certain prior-art documents describe a reinforcing rib structure, as for instance in EP 411 830 A, EP 343 896 A, U.S. Pat. No. 5,145,544 and U.S. Pat. No. 5,173,141. In these cases the ribs protrude in part from the surface and are in part embedded in the film surface. Notched joints are formed between film and ribs. A substantial deficiency is that the film cannot be manufactured on the production scale. Further disadvantages are set out in the abovementioned DE 199 55 610 A1.

It is an object of the invention to provide an adhesive tape which combines a comparatively low thickness with a very high tear propagation resistance in cross direction (cd) and a very high tensile strength in machine direction (md).

### SUMMARY OF THE INVENTION

This object is achieved by an adhesive tape with a backing of a polymer material and with an adhesive, the backing material being composed of a multiplicity of strips which are oriented in machine direction and are aligned in the machine direction of the adhesive tape. The multiplicity of strips are fixed to one another, in particular by means of an auxiliary backing film.

In contrast to the solutions proposed in the prior art, the present invention requires neither reinforcing filaments nor a film having a plurality of coextruded layers.

### DETAILED DESCRIPTION

The underlying adhesive tape here is similar in its tensile strength to a film-backed adhesive tape with a conventionally oriented monofilm. Furthermore, as a result of the production of numerous intact and undamaged film side edges across the width of the adhesive tape, the present invention allows the necessary tear propagation resistance. With its side edge undamaged, an adhesive tape with an oriented film backing such as MOPP, for example, has good tear resistance. However, if the side edge has been damaged, deliberately or unintentionally, the tear propagation resistance is low. In the present invention, in the event of side damage, one of the edges located further in the interior of the adhesive tape replaces the damaged outer edge and so places the adhesive tape back into a state in which it is undamaged, as it were, for the rest of the remaining backing width.

The backing of the adhesive tape of the invention is composed accordingly of a composite of polymer materials, with a multiplicity of film strips provided on one side of a first film, the aforementioned auxiliary backing film. These film strips run parallel and very preferably in the machine direction of the adhesive tape, so that the film side edges of the individual film strips are aligned parallel to the side edges of the adhesive tape. Advantageously the film strips are oriented in machine direction.

The strips may have different widths. It is, however, particularly preferred for all strips to have the same width. As a consequence of the manufacturing process, the two outer strips may have a deviating width.

In order to provide additional inner edges by means of the strips, at least two film strips are envisaged, in the sense of the aforementioned multiplicity. In that case the cut edge can be disposed centrally, so that two strips are of equal width. It is, however, also possible to manufacture “asymmetrical” adhesive strips, where one strip is broader than the second strip and where, in particular, the further-tearability has been reduced from the side of the narrower strip.

The number of strips can be increased in principle arbitrarily, the upper limit on the strip number being governed by the width of the adhesive tape and the strip width. Thus it is possible, for example, to manufacture even symmetrical or asymmetrical adhesive tapes with three strips, examples being those in which one inner edge in each case is provided as a tear limit in the vicinity of the adhesive tape edges.

The width of the strips is with particular preference between 1 and 4 mm, very preferably about 2 mm. Particularly in the case of strips which have a low width in relation to the width of the adhesive tape, an equal strip width is of advantage.

The strips advantageously lie close together, but without overlapping. Between these strips there may also be gaps left, particularly as a result of these gaps forming as a result of “narrowing” when the initially unoriented strips are oriented. For reasons of stability, the width of the gaps preferably does not exceed half of the width of the strips.

In a further embodiment of the invention, however, broader gaps are envisaged, in particular for reasons of economy of material. In that case the width of the gaps may with particular advantage be implemented up to the width of the strips, or may even exceed their width.

### BRIEF DESCRIPTION OF THE DRAWINGS

FIG. 1 shows, diagrammatically, the construction of an adhesive tape of the invention in cross section, with film strips (1) arranged in parallel being provided on a backing film (2). In the exemplary depiction a layer of a pressure-sensitive adhesive (3) is applied to sides of the film strips. In the embodiment depicted there are gaps (4) between the individual strips (1).

FIG. 2a) shows, diagrammatically, an arrangement of the strips (1), lying close to one another, on an auxiliary backing film (2), the adhesive layer not being depicted so as to aid perception.

FIG. 2b) shows an arrangement similar to that of FIG. 2a) in which gaps (3) are provided between the strips (1).

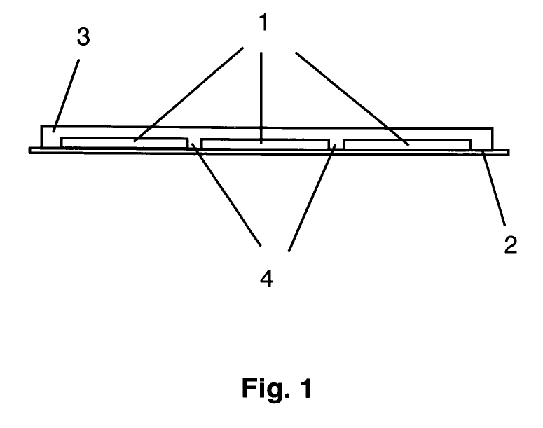

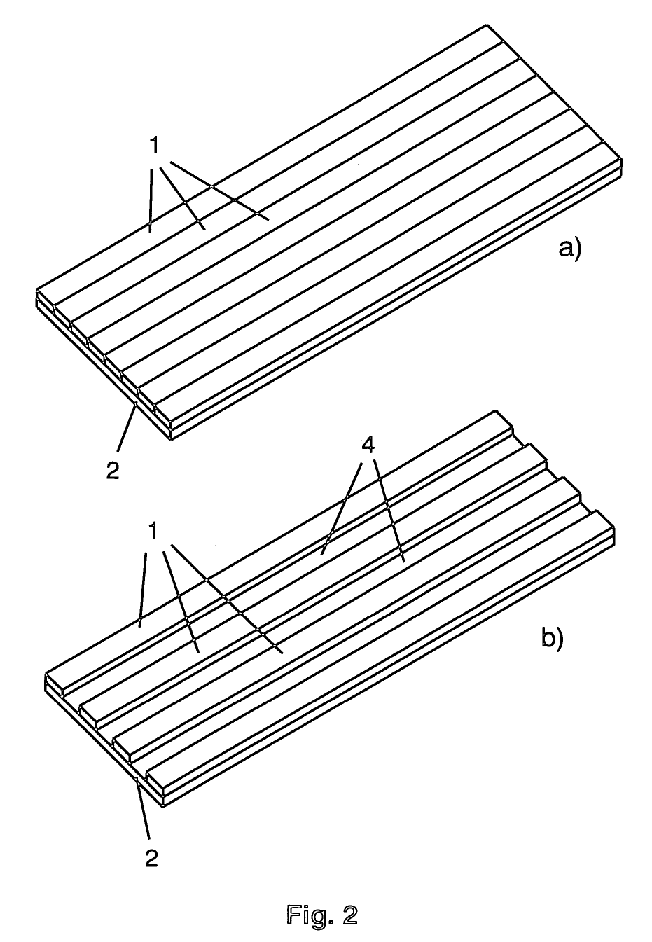

One preferred example of an adhesive tape has strips approximately 2 mm wide with an adhesive tape approximately 15 mm wide, the width of each gap not exceeding half the strip width.

In the case of one method of producing undamaged film side edges, an extruded monofilm, following extrusion, is slit multiply in machine direction, producing a multiplicity of adjacent film strips. In order to give the film the necessary longitudinal strength, the individual film strips are subsequently oriented. The orientation of the film strips, comparably to the orientation of a film in full machine width, can be carried out in accordance with a customary market film orienting process. With particular preference the film strips are oriented in their longitudinal direction.

For improved further processing, such as in particular the operation of coating with pressure-sensitive adhesive, the films strips are fixed adjacently. Fixing is done preferably by means of a further film (“auxiliary backing film”), which is applied by means of extrusion, for example, to the film strips.

The oriented film strips may be composed of any of a wide variety of materials (for example MOPP, PP, PE, PET, PA, PU, PVC). Preferred suitability is possessed by all polymers which are also employed for conventionally oriented films, such as polypropylene for the manufacture of MOPP, for example. The thickness of the films that form the strips is preferably 20 to 80 μm, more preferably 40 to 70 μm.

Independently of the polymer of the oriented film strips, the material of the fixing auxiliary backing film can be chosen freely, and in particular it is possible to employ the materials already mentioned above. Preferential suitability is possessed by polymers which give the adhesive tape a smooth reverse with easy unwind, such as polyethylene, for example. The thickness of the auxiliary backing film is preferably 8 to 20 μm, more preferably 10 μm.

The steps specified above result in adhesive tapes having a high strength but with a thickness which is well below that of prior-art adhesive tapes for corresponding applications. Thus it is possible to produce adhesive tapes at less than 140 μm, in particular less than 100 μm, very particularly less than 70 μm. By way of example a composite backing material has been achieved which has a strength of approximately 300 N/mm² for a thickness of not more than 60 μm, and which is very suitable as backing material for the adhesive tape of the invention.

Similarly to what is the situation with filament yarns, the film strips constitute a periodically recurring tear stopper. In contrast to those yarns, however, film strips offer the advantage that the frequency of the tear stopper points can be varied, within certain limits, independently of the material employed.

As compared with filament-reinforced adhesive tapes, a variety of advantages come about as a result of the backing material used for the adhesive tape of the invention. Film materials which can be extruded and oriented are in principle resistant to crease fracture, a property which is not present in the case of glass filaments, for example. In contrast to twisted or tangled filaments, the film strips with parallel alignment have the same minimum length. Hence any parallel tensile force acts on each film strip directly and at the same time is taken on, in accordance with requirement, by a plurality of strips. This leads to a particularly effective accommodation of force.

In comparison to a “cross-filament” tape there is a further advantage. As a result of the woven structure of a woven fabric, the warp threads experience an additional deflection in the z direction at the nodal points, with the above-described consequence for the behaviour under tensile load. In the case of the adhesive tape of the invention, in contrast, the load acts directly on the film strips, hence allowing optimum accommodation of force.

In contrast to filament-reinforced adhesive tapes, moreover, the thickness is levelled in cross section. The film strips are substantially thinner than rounded filament bundles and lie close to one another, separated in particular only by small gaps, which come about as a result of the contraction experienced during orientation. This levelling leads to a reduction in the maximum backing thickness of the adhesive tape.

As a result of the orientation under tension, the arrangement of the film strips can be made exactly parallel and very uniform. Superimpositions are avoided. This contributes likewise to optimum space utilization and minimization of thickness.

For the adhesive tape of the invention the composite composed of the flatly arranged film strips and the auxiliary backing film is provided with an adhesive, in particular a pressure-sensitive adhesive. In this context it may be sensible first to treat the side of the film that is to be provided with the pressure-sensitive adhesive with a primer (preliminary coat). The adhesive is provided advantageously on the side of the composite on which the film strips are located. Also included in the concept of the invention, however, is an adhesive tape in which the (pressure-sensitive) adhesive is provided on the side of the auxiliary backing film.

The film composite may also be used as a backing for a double-sided (pressure-sensitive) adhesive tape, in which, therefore, a (pressure-sensitive) adhesive is provided in each case not only the side of the film strips but also on the side of the auxiliary backing film. In this way it is possible to provide a tear propagation resistant, double-sided adhesive tape which avoids the disadvantages of the prior art.

The adhesive of the adhesive tapes of the invention may be a (self-adhesive from the group of the natural rubbers or synthetic rubbers, or is composed of any desired blend of natural rubbers and/or synthetic rubbers, it being possible for the natural rubber or rubbers to be selected in principle from all available grades, such as, for example, crepe, RSS, ADS, TSR or CV grades, depending on required purity and viscosity level, and for the synthetic rubber or rubbers to be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible to improve the processing properties of the rubbers by adding thermoplastic elastomers to them with a weight fraction of 10% to 50% by weight, based on the total elastomer fraction. Representatives that may be mentioned at this point include in particular the especially compatible styrene-isoprene-styrene (SIS) and styrene-butadiene-styrene (SBS) grades.

In addition, a 100% SIS compound may be used to outstanding effect.

Tackifying resins which can be used include, without exception, all tackifier resins already known and described in the literature. Representatives that may be mentioned include the rosins, their disproportionated, hydrogenated, polymerized, and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements.

Crosslinking is advantageous for improving the removability of the adhesive tape after the application, and may take place thermally or by irradiation with UV light or electron beams.

For the purpose of thermally induced chemical crosslinking it is possible to employ all known thermally activable chemical crosslinkers, such as accelerated sulphur systems or sulphur donor systems, isocyanate systems, reactive melamine resins, formaldehyde resins and (optionally halogenated) phenol-formaldehyde resins and/or reactive phenolic resin systems. or diisocyanate crosslinking systems with the corresponding activators, epoxidized polyester resins and acrylate resins, and also combinations of these. The crosslinkers are activated preferably at temperatures above 50° C., in particular at temperatures of 100° C. to 160° C., very preferably at temperatures of 110° C. to 140° C. Thermal excitation of the crosslinkers may also take place by means of IR rays or high-energy alternating fields.

An adhesive which has proven to be advantageous is one based on acrylate hotmelt, which has a K value of at least 20, in particular more than 30, and is obtainable by concentrating a solution of such an adhesive to give a system which can be processed as a hotmelt.

Concentration may take place in appropriately equipped tanks or extruders; particularly in the case of accompanying devolatilization, a devolatilizing extruder is preferred. An adhesive of this kind is set out in DE 43 13 008 A1/U.S. Pat. No. 6,613,870, whose content is hereby incorporated by reference to be part of this disclosure and invention. Alternatively, the acrylate hotmelt-based adhesive can be chemically crosslinked.

In one preferred embodiment the self-adhesives used are copolymers of (meth)acrylic acid and the esters thereof having 1 to 25 carbon atoms, maleic, fumaric and/or itaconic acid and/or their esters, substituted (meth)acrylamides, maleic anhydride and other vinyl compounds, such as vinyl esters, especially vinyl acetate, vinyl alcohols and/or vinyl ethers.

The residual solvent content should be below 1% by weight.

One adhesive which is found to be particularly suitable is a low molecular mass acrylate hotmelt pressure-sensitive adhesive of the kind carried under the name acResin UV or Acronal®, especially Acronal® DS 3458, by BASF. This low-K-value adhesive acquires its application-compatible properties by means of a concluding, radiation-induced chemical crosslinking.

The application of adhesive is preferably between 15 to 60 g/m², more preferably 30 g/m².

The adhesive tape, finally, may have a liner material, with which the one or two layers of adhesive are lined until use. Suitable liner materials include all of the materials listed in detail above. Preference, however, is given to using a non-fluffing material such as a polymeric film or a well-sized, long-fibred paper.

In order to be adhesive, a pressure-sensitive adhesive requires a certain minimum layer thickness, depending on the nature of the pressure-sensitive adhesive. This minimum layer thickness must be achieved over the entire width of the adhesive tape. If there is an uneven distribution of fibres, as in the case of fibre bundles, for example, the highest point in the cross section of the adhesive tape determines the necessary coatweight, since the required minimum layer thickness must be present on the fibre backs and/or on the nodal points in open filament wovens as well. A large quantity of adhesive is lost to no effect in filling up the gaps between the fibre bundles.

A further advantage of the present invention derives, consequently, from the fact that, as a result of the use of film strips as backing material, there are no voluminous gaps between them, which would have to be filled up in order to achieve the minimum layer thickness across the entire width of the adhesive tape. Since all of the adhesive is effectively available for the bonding performance, a thinner layer of adhesive can be applied for the same bond strength; in other words, less adhesive can be used. And there is no need for a layer of adhesive which usually fixes the filament bundles to their backing film. Both together result in a saving in material terms and hence in not only cost but also weight.

The adhesive tape of the invention can be used with advantage in the fields of application as described in U.S. Pat. No. 2,750,315. These include, for example, bundling, packing, palletizing, use similarly to a tightening belt, etc. The feature common to said applications is the fixing of one or more articles to itself or themselves, to one another or to further objects.

Besides the abovementioned applications the tape is outstandingly suitable for all functions requiring a reinforcing action of load-bearing elements in combination or, selectively, individually with resistance to inward tearing and to tear propagation. Materials which can be reinforced include, for example those such as paper, corrugated board or solid board, preferably at exposed positions such as grips, handles and cutouts. The tape can also be used as a constructional element in order, for example, to prevent relatively heavy packaging from becoming floppy. This produces advantages such as
the upgrading of packs for greater challenges
the reduction in the total amount of material used, as a result of deliberate strengthening of the zones of principal loading
an increase in the useful life of a pack.

The composite of polymer materials in which there are a multiplicity of film strips on one side of an auxiliary backing film, this composite being of the kind used as backing material for the adhesive tapes presented above, can also be employed very effectively on its own, in other words without the adhesives, as a covering or protecting film material, particularly in any applications where the film is exposed to heightened mechanical stresses and therefore runs the risk of tearing easily. In this situation the prior-art films either exhibit the described tear propagation tendency or require the efforts described at the outset in order to achieve tear resistant or tear propagation resistant films. The aforementioned film here as well allows the offering of a tear resistant film, without displaying the disadvantages of the prior art.

1. Adhesive tape comprising a backing of a polymer material, and an adhesive, wherein the backing material is composed of a multiplicity of strips which are oriented in machine direction and aligned in machine direction, the multiplicity of strips being fixed to an auxiliary backing film.

2. Adhesive tape according to claim 1, wherein the strips are joined to the auxiliary backing film by extrusion.

3. Adhesive tape according to claim 1, wherein the auxiliary backing film is provided on the side of the strips facing away from the adhesive.

4. Adhesive tape according to claim 1, wherein the adhesive is a pressure-sensitive adhesive.

5. A method for bundling, packing or palletizing which comprises bundling, packing or palletizing with the adhesive tape of claim 1.

6. A method of reinforcing paper, corrugated board or solid board, which comprises reinforcing said paper, corrugated board or solid board with the adhesive tape of claim 1.

7. The method of claim 6, where said reinforcing is at grips, handles or cutouts in or on said paper, corrugated board or solid board.
